(19) United States
(12) Patent Application Publication
(10) Pub. No.: US 2010/0056420 A1
(43) Pub. Date: Mar. 4, 2010

(54) FABRIC CARE COMPOSITIONS COMPRISING CATIONIC POLYMERS AND ANIONIC SURFACTANTS

(76) Inventors: Alessandro Corona, III, Mason, OH (US); Brian W. Everingham, Cincinnati, OH (US); Gayle Marie Frankenbach, Cincinnati, OH (US); Rajan Keshav Panandiker, West Chester, OH (US); Mark Robert Sivik, Mason, OH (US); Beth Ann Schubert, Maineville, OH (US); Mario Elmen Tremblay, West Chester, OH (US); Kerry Andrew Vetter, Cincinnati, OH (US); Gregory Thomas Waning, Fairfield, OH (US); Jeffrey Scott Weaver, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/549,712

(22) Filed: Aug. 28, 2009

Related U.S. Application Data
(60) Provisional application No. 61/092,633, filed on Aug. 28, 2008.
(60) Provisional application No. 61/221,632, filed on Jun. 30, 2009.

(51) Int. Cl. C11D 17/08

(52) U.S. Cl. 510/341; 510/340

(57) ABSTRACT

Isotropic compositions containing one or more cationic polymers, one or more anionic surfactants, one or more amphoteric surfactants, and optionally, one or more dispersing agents, are disclosed. The disclosed compositions are suitable for delivering one or more benefits to a fabric. In one aspect, the benefit delivered to the fabric is a color benefit.

### CROSS REFERENCE TO RELATED APPLICATIONS

This application claims priority under 35 U.S.C. §119(e) to U.S. Provisional Application Ser. No. 61/092,633 filed Aug. 28, 2008, and U.S. Provisional Application Ser. No. 61/221,632 filed Jun. 30, 2009.

### FIELD OF THE INVENTION

Fabric care compositions comprising cationic polymers and anionic surfactants as well as methods of making and using same.

### BACKGROUND OF THE INVENTION

When used in compositions, cationic polymers and anionic surfactants tend to interact due to the opposing charge of the materials. In many cases, particularly where higher levels of these agents are used, cationic polymer and anionic surfactant can interact to the point of causing flocculation. In some instances, higher levels of cationic polymer and anionic surfactant cannot be combined to form a stable, isotropic solution, but rather, the use of structurants and/or complex processing steps is required to form a composition suitable for consumer use.

Despite these drawbacks, it remains desirable at times to provide compositions having higher levels of cationic polymers—for example, to provide one or more benefits to a fabric in a fabric treatment composition—in compositions that may contain anionic surfactants. However, the above-described properties of cationic polymers can make formulation of stable compositions containing these polymers problematic. Further, inclusion of high amounts of cationic polymer can also, in some cases, compromise cleaning efficacy, as a result of cationic polymer interacting with anionic surfactant that would otherwise provide a cleaning effect.

Accordingly, there remains a need for stable formulations that provide one or more care benefits, such as a color benefit. There further remains a need for compositions containing a cationic polymer but which do not compromise cleaning during the laundering process.

The instant compositions address one or more of the aforementioned needs.

### SUMMARY OF THE INVENTION

Isotropic compositions containing one or more cationic polymers, one or more anionic surfactants, one or more amphoteric surfactants, and optionally, one or more dispersing agents, are disclosed. The disclosed compositions are suitable for delivering one or more benefits to a fabric. In one aspect, the benefit delivered to the fabric is a color benefit.

### DETAILED DESCRIPTION OF THE INVENTION

As used herein, the articles “a” and “an” when used in a claim, are understood to mean one or more of what is claimed or described.

As used herein, the term “additive” means a composition or material that may be used separately from (but including before, after, or simultaneously with) the detergent during a laundering process to impart a benefit to the treated fabric.

As used herein, the term “black” as applied to a garment, may be defined as the color measured by Hunter L with an L value range from about 0 to about 18. An example of a black color specification is palette number 19-4005tc used as black for the black T-shirt manufactured and sold by the Gildan textile company, 600 de Maisonneuve West, 33rd Floor, Montreal (Quebec), H3A 3J2 Canada. This color also corresponds in the CMYK Color Model of 100-35-0-100 wherein CMYK is defined as C for cyan, M for magenta, Y for yellow, and K is key for black. The CMYK ISO standard is ISO 12640-1:1997 and can be accessed at www.iso.org.

As used herein, the term “coacervate” means a particle formed from the association of a cationic polymer and an anionic surfactant in an aqueous environment. The term “coacervate” may be used interchangeably with the terms “primary particle,” “colloidal particle,” and “aggregate particle.”

As used herein, “charge density” refers to the charge density of the polymer itself and may be different from the monomer feedstock. Charge density may be calculated by dividing the number of net charges per repeating unit by the molecular weight of the repeating unit. The positive charges may be located on the backbone of the polymers and/or the side chains of polymers. For polymers with amine monomers, the charge density depends on the pH of the carrier. For these polymers, charge density is measured at a pH of 7. ACD refers to anionic charge density, while CCD refers to cationic charge density.

As used herein, the term “comprising” means various components conjointly employed in the preparation of the compositions of the present disclosure. Accordingly, the terms “consisting essentially of” and “consisting of” are embodied in the term “comprising”.

As used herein, “essentially free of” a component means that no amount of that component is deliberately incorporated into the composition.

As used herein, “fabric care and/or cleaning compositions” include fabric care compositions for handwash, machine wash and/or other purposes and include fabric care additive compositions and compositions suitable for use in the soaking and/or pretreatment of fabrics. They may take the form of, for example, laundry detergents, fabric conditioners and/or other wash, rinse, dryer added products, and sprays. Fabric care compositions in the liquid form may be in an aqueous carrier. In other aspects, the fabric care compositions are in the form of a granular detergent or dryer added fabric softener sheet. The term “fabric care and/or cleaning compositions” includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; cleaning auxiliaries such as bleach additives and “stain-stick” or pre-treat types, substrate-laden products, dry and wetted wipes and pads, nonwoven substrates, and sponges; and sprays and mists. Various dosage formats may be used. The fabric care and/or cleaning composition may be provided in pouches, including foil or plastic pouches or water soluble pouches, such as a polyvinyl alcohol (PVA) pouch; dosing balls or containers; containers with readily opened closures, such as pull tabs, screw caps, foil or plastic covers, and the like; or other container known in the art. The compositions may be compact compositions, comprising, based on total weight of the composition, less than about 15% water, or less than about 10% water, or less than about 7% water.

As used herein, “isotropic” means a clear mixture, having a % transmittance of greater than 50% at a wavelength of 570 nm measured via a standard 10 mm pathlength cuvette with a Beckman DU spectrophotometer, in the absence of dyes and/or opacifiers.

As defined herein, “stable” means that no visible phase separation is observed for a period of at least about two weeks, or at least about four weeks, or greater than about a month or greater than about four months, as measured using the Floc Formation Test, described in U.S.P.A. 2008/0263780 A1.

As used herein, the terms “rejuvenation” or “restoration” of a fabric means enhancing or making more vivid or vibrant the appearance of colored or dyed fabrics. Rejuvenation or restoration can be determined empirically by calculating the ΔL value using the methods described herein, wherein a treated fabric has a ΔL value of greater than about −0.01. The term includes restoring the color appearance of a faded fabric and improving the color appearance of a new or faded fabric to “better than new.”

As used herein, “unit dose” or “unitized dose” means an amount of fabric care composition suitable to treat one load of laundry, such as from about 0.05 g to about 100 g, or from 10 g to about 60 g, or from about 20 g to about 40 g.

All measurements are performed at 25° C. unless otherwise specified.

The test methods disclosed in the present application should be used to determine the respective values of the parameters of Applicants' invention.

Unless otherwise noted, all component or composition levels are in reference to the active portion of that component or composition, and are exclusive of impurities, for example, residual solvents or by-products, which may be present in commercially available sources of such components or compositions.

Without being bound by theory, Applicants have recognized that, by using amphoteric and/or nonionic surfactants in combination with cationic polymers, with or without other surfactants, stable and isotropic compositions may be obtained. Such compositions may be useful as an additive (i.e., used in combination with other laundering agents) capable of providing one or more fabric care benefits. In one aspect, the benefit may comprise a color care benefit. Without being bound by theory, Applicants believe that one or more fabric care benefits of the disclosed compositions are delivered via a coacervate mechanism, particularly when used with a source of anionic surfactant under laundering conditions. The resulting coacervate that forms during laundering conditions is believed to contact and coat the fibers of a fabric during the laundering process. This, in turn, results in one or more benefits to a fabric, including reduced refraction of light and an improved fabric appearance.

In another aspect, Applicants have recognized that by addition of amphoteric surfactant, less anionic surfactant is needed to achieve the same level of cleaning. Further, Applicants have recognized that by reducing the amount of anionic surfactant content used, in the disclosed additives, product stability may be improved.

In another aspect, Applicants have recognized that amphoteric surfactants in the disclosed compositions results in the formation of smaller particles under wash conditions. Without being bound by theory, it is believed that these smaller particles have a greater affinity for fabrics, thereby more efficiently providing a benefit, such as a color benefit, to the fabric.

In one aspect, a composition comprising
a. from about 1% to about 12%, or from about 2% to about 8%, or from about 3% to about 5%, based on total weight of the composition, of a cationic polymer;
b. from about 1% to about 20%, or from about 2% to about 15%, or from about 3% to about 10%, based on total weight of the composition, of an amphoteric surfactant;
c. optionally, from about 1% to about 30%, or from about 3% to about 20%, or from about 5% to 10%, based on total weight of the composition, of an anionic surfactant;
d. optionally, from about 1% to about 20%, or from about 2% to about 15%, or from about 3% to about 10%, based on total weight of the composition, of a nonionic surfactant;
e. optionally, a dispersing agent,
wherein said composition may be isotropic, is disclosed.

In one aspect, said composition may comprise
a. from about 1% to about 12%, or from about 2% to about 8%, or from about 3% to about 5%, based on total weight of the composition, of a cationic polymer
b. from about 1% to about 10%, or from about 2% to about 15%, or from about 3% to about 10%, based on total weight of the composition, of an amphoteric surfactant;
   wherein said composition may be essentially free of anionic surfactant and/or nonionic surfactant.

In one aspect, said composition may comprise
a. from about 1% to about 12%, or from about 2% to about 8%, or from about 3% to about 5%, based on total weight of the composition, of a cationic polymer
b. from about 1% to about 20%, or from about 2% to about 15%, or from about 3% to about 10%, based on total weight of the composition, of a nonionic surfactant;
   wherein said composition may be essentially free of anionic surfactant.

In one aspect, said composition may consist essentially of
a. from about 1% to about 12%, or from about 2% to about 8%, or from about 3% to about 5%, based on total weight of the composition, of a cationic polymer;
b. from about 1% to about 30%, or from about 3% to about 20%, or from about 5% to 10%, based on total weight of the composition, of an anionic surfactant;
c. from about 1% to about 10%, or from about 2% to about 15%, or from about 3% to about 10%, based on total weight of the composition, of an amphoteric surfactant; and
d. a carrier, wherein in one aspect, the carrier may comprise water.

In one aspect, said composition may comprise a ratio of amphoteric surfactant to anionic surfactant of from about 1:1 to about 3:1, or from about 1.5:1 to about 2:1.

In one aspect, said composition may be essentially free of secondary alkane sulfonate.

Cationic Polymer—In one aspect, the cationic polymer may comprise a cationic polymer produced by polymerization of ethylenically unsaturated monomers using a suitable initiator or catalyst. These are disclosed in WO 00/56849 and U.S. Pat. No. 6,642,200.

In one aspect, the cationic polymer may be selected from the group consisting of cationic or amphoteric polysaccharides, polyethyleneimine and its derivatives, a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, Methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof. The cationic polymer may optionally comprise a second monomer selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glycol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may be a terpolymer made from more than two monomers. The polymer may optionally be branched or cross-linked by using branching and crosslinking monomers. Branching and crosslinking monomers include ethylene glycoldiacrylate divinylbenzene, and butadiene. In one aspect, the cationic polymer may include those produced by polymerization of ethylenically unsaturated monomers using a suitable initiator or catalyst, such as those disclosed in WO 00/56849 and U.S. Pat. No. 6,642,200. In one aspect, the cationic polymer may comprise charge neutralizing anions such that the overall polymer is neutral under ambient conditions. Suitable counter ions include (in addition to anionic species generated during use) include chloride, bromide, sulfate, methylsulfate, sulfonate, methylsulfonate, carbonate, bicarbonate, formate, acetate, citrate, nitrate, and mixtures thereof.

In one aspect, the cationic polymer may be selected from the group consisting of poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-methacryloamidopropyl-pentamethyl-1,3-propylene-2-ol-ammonium dichloride). These cationic polymers include and may be further described by the nomenclature Polyquaternium-1, Polyquaternium-5, Polyquaternium-6, Polyquaternium-7, Polyquaternium-8, Polyquaternium-1, Polyquaternium-14, Polyquaternium-22, Polyquaternium-28, Polyquaternium-30, Polyquaternium-32 and Polyquaternium-33, as named under the International Nomenclature for Cosmetic Ingredients.

In one aspect, the cationic polymer may comprise a cationic acrylic based polymer. In one aspect, the cationic polymer may comprise a cationic polyacrylamide. In one aspect, the cationic polymer may comprise poly(acrylamide-N,N-dimethylaminoethyl acrylate) and its quaternized derivatives. In this aspect, the cationic polymer may be that sold under the tradename Sedipur®, available from BTC Specialty Chemicals, BASF Group, Florham Park, N.J.

In one aspect, the cationic polymer may comprise poly(acrylamide-co-methacrylamidopropyltrimethyl ammonium chloride).

In one aspect, the cationic polymer may comprise a non-acrylamide based polymer, such as that sold under the tradename Rheovis® CDE, available from Ciba Specialty Chemicals, a BASF group, Florham Park, N.J., or as disclosed in USPA 2006/0252668.

In one aspect, the cationic polymer may comprise polyethyleneimine or a polyethyleneimine derivative. In one aspect, the cationic polymer may be a polyethyleneinine such as that sold under the tradename Lupasol® by BASF, AG, Lugwigschaefen, Germany

In one aspect, the cationic polymer may include alkylamine-epichlorohydrin polymers, which are reaction products of amines and oligoamines with epicholorohydrin. These include those polymers listed in U.S. Pat. Nos. 6,642,200 and 6,551,986. Examples include dimethylamine-epichlorohydrin-ethylenediamine, and available under the trade name Cartafix® CB and Cartafix® TSF from Clariant, Basle, Switzerland.

In one aspect, the cationic polymer may comprise a synthetic cationic polymer comprising polyamidoamine-epichlorohydrin (PAE) resins of polyalkylenepolyamine with polycarboxylic acid. The most common PAE resins are the condensation products of diethylenetriamine with adipic acid followed by a subsequent reaction with epichlorohydrin. They are available from Hercules Inc. of Wilmington Del. under the trade name Kymene™ or from BASF AG (Ludwigshafen, Germany) under the trade name Luresin™. These polymers are described in Wet Strength resins and their applications edited by L. L. Chan, TAPPI Press (1994), at pp. 13-44.

In one aspect, the cationic polymer may be selected from the group consisting of cationic or amphoteric polysaccharides. In one aspect, the cationic polymer may comprise a polymer selected from the group consisting of cationic and amphoteric cellulose ethers, cationic or amphoteric galactomanan, cationic guar gum, cationic or amphoteric starch, and combinations thereof.

In one aspect, the cationic polymer may comprise an amphoteric polymer, provided the polymer possesses a net positive charge. Said polymer may have a cationic charge density of about 0.05 to about 18 milliequivalents/g.

In one aspect, the cationic polymer may have a cationic charge density of from about 0.005 to about 23, from about 0.01 to about 12, or from about 0.1 to about 7 milliequivalents/g, at the pH of the intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

In one aspect, the cationic polymer may have a weight-average molecular weight of from about 500 to about 5,000,000, or from about 1,000 to about 2,000,000, or from about 2,500 to about 1,500,000 Daltons as determined by size exclusion chromatography relative to polyethyleneoxide standards with RI detection. In one aspect, the molecular weight of the cationic polymer may be from about 500 to about 37,500 kD. The cationic polymers may also range in both molecular weight and charge density. The cationic polymer may have a charge density of from about 0.05 meq/g to about 12 meq/g, or from about 1.0 to about 6 meq/q, or from about 3 to about 4 meq/g at a pH of from about pH 3 to about pH 9. In one aspect, the one or more cationic polymer may have a weight-average molecular weight of 500 Daltons to about 37,500 Daltons and a charge density from about 0.1 meq/g to about 12.

Anionic Surfactant—In one aspect, the anionic surfactant may comprise a material selected from the group consisting of C₈-C₂₂ fatty acid or its salts; C₁₁-C₁₈ alkyl benzene sulfonates; C₁₀-C₂₀ branched-chain and random alkyl sulfates; C₁₀-C₁₈ alkyl ethoxy sulfates, wherein x is from 1-30; mid-chain branched alkyl sulfates; mid-chain branched alkyl alkoxy sulfates; C₁₀-C₁₈ alkyl alkoxy carboxylates comprising 1-5 ethoxy units; modified alkylbenzene sulfonate; C₁₂-C₂₀ methyl ester sulfonate; C₁₀-C₁₈ alpha-olefin sulfonate; C₆-C₂₀ sulfosuccinates; and combinations thereof. In one aspect, the anionic surfactant may be alkylethoxysulfonate. In one aspect, the anionic surfactant may be linear alkylbenzene sulfonate.

Nonionic Surfactant—In one aspect, the nonionic surfactant may comprise a surfactant selected from the group consisting of ethoxylates, multihydroxyl surfactants, and mixtures thereof. In one aspect, the nonionic surfactant may comprise an ethoxylate surfactant. In one aspect, the nonionic surfactant may comprise an ethoxylate selected from the group consisting of alcohol ethoxylates, mono alkanolamide ethoxylates, fatty amine ethoxylates, fatty acid ethoxylates, ethylene oxide/propylene oxide copolymers, alkyl phenol ethoxylates, and combinations thereof. In one aspect, the nonionic surfactant may comprise linear alcohol ethoxylate surfactant having from about 6 to about 10 moles of ethoxylation.

Amphoteric surfactants—In one aspect, the amphoteric surfactant may comprise a surfactant selected from the group consisting of N-alkyl aminoproprionates, N-alkyl betaines, N-alkyl glycinates, carboxy glycinates, alkyl imidazoline-based surfactants, amine oxides, and combinations thereof. In one aspect, the amphoteric surfactant may comprise a betaine. In one aspect, the betaines may comprise one or both of carbobetaines and sulfobetaines. In one aspect, the betaines may comprise a betaine selected from the group consisting of carboxymethylammoniumbetaines, especially C₈-C₁₈ alkyldimethylcarboxymethylammoniumbetaines, C₈-C₁₈ alkylamidopropyldimethylcarboxymethylammoniumbetaines, C₈-C₁₈ alkyldipolyethoxycarboxymethylammoniumbetaines, and combinations thereof. Other suitable betaines may include, for example, the N-carboxyethylammoniumbetaines analogous to the compounds listed above, wherein chloropropionic acid and its salts are used for the synthesis instead of chloroacetic acid or its salts. Examples include the C₁₂-C₁₈ alkyl aminopropionates and C₁₂-C₁₈ alkyl iminodipropionates as the alkali and mono-, di- and trialkylammonium salts. In one aspect, the amphoteric surfactant may comprise cocoamido-betaine.

Dispersing Agents—The compositions may optionally comprise a dispersing agent. In this aspect, the composition may comprise, based on total weight of the composition, from about 0.1% to about 10%, or from about 0.5% to about 5%, or from about 1% to about 3%, of a dispersing agent.

In one aspect, the dispersing agent may comprise a fatty amine selected from the group consisting of octyl amine (CAS RN: 111-86-4), lauryl amine (CAS RN: 124-22-1), stearyl amine (CAS RN: 124-30-1), oleyl amine (CAS RN: 112-90-3), tallowamine (CAS RN: 61790-33-8), cetylamine (CAS RN: 143-27-1), N-tetradecylamine (CAS RN: 2016-42-4), cocoamine (CAS RN: 61788-46-3)), hydrogenated tallowamine (CAS RN: 61788-45-2), alkyl(C16 and C18-unsaturated) amine (CAS RN: 68855-63-0), alkyl(C14-18) amine (CAS RN: 68037-91-2), alkyl(C₁₆₋₂₂) amine (CAS RN: 68037-92-3), alkyl(C₈₋₁₈ and C₁₈-unsaturated) amine (CAS RN: 68037-94-5), alkyl(C12-18) amine (CAS RN: 68155-27-1), di(hydrogenated tallow)amine (CAS RN: 61789-79-5, dicocoalkyl amine (CAS RN: 61789-76-2), dialkyl(C₁₄₋₁₈) amine (CAS RN: 68037-98-9), dialkyl (C₁₂₋₁₈) amine (CAS RN: 68153-95-7), dialkyl(C₁₆₋₂₂) amine (CAS RN: 68439-74-7), N-tridecyltridecanamine (CAS RN: 68513-50-8), N-methylstearylamine (CAS RN: 2439-55-6), distearyl amine (CAS RN: 112-99-2), dialkyl(C₈₋₂₀) amine (CAS RN: 68526-63-6), N-octadecylbenzylamine (CAS RN: 20198-87-2), N-isopropyloctadecylamine (CAS RN: 13329-71-0), N-hexadecyloctadecylamine (CAS RN: 45310-14-3), dimantine (CAS RN: 124-28-7), N-methyldioctadecylamine (CAS RN: 4088-22-6), dimethyl palmitamine (CAS RN: 112-69-6), cocodimethylamine (CAS RN: 61788-93-0), alkyl (C10-16) dimethyl amine (CAS RN: 67700-98-5), alkyl(C₁₄₋₁₈)dimethyl amine (CAS RN: 68037-93-4), alkyl(C₁₆₋₁₈ and C₁₈-unsaturated)dimethyl amine (CAS RN: 68037-96-7), alkyl(C₁₆₋₁₈) dimethyl amine (CAS RN: 68390-97-6), Alkyl(C₁₂₋₁₈)dimethyl amine (CAS RN: 68391-04-8), alkyl(C16-22)dimethyl amine (CAS RN: 75444-69-8), oleyldimethylamine (CAS RN: 71662-63-0), N-methyldidecylamine (CAS RN: 7396-58-9), N,N-dioctylmethylamine (CAS RN: 4455-26-9), dicocomethylamine (CAS RN: 61788-62-3), dihydrogenated tallowmethyl amine (CAS RN: 61788-63-4), trialkyl (C₆₋₁₂) amine (CAS RN: 68038-01-7), N,N-dioctyloctyl amine (CAS RN: 68439-83-8), trialkyl(C₈₋₁₀) amine (CAS RN: 68814-95-9). cocopropylenediamine (CAS RN: 61791-63-7), laurylpropylenediamine (CAS RN: 10443-36-4), N-dodecylpropylenediamine (CAS RN: 30677-46-4), laurylamine dipropylenediamine (CAS RN: 2372-82-9), N-(tallow alkyl)dipropylenetriamine (CAS RN: 61791-57-9), N-(tallow alkyl)dipropylenetriamine (CAS RN: 61791-57-9), N-stearoyltetraethylenetetramine (CAS RN: 4040-54-4), and mixtures thereof. In one aspect, the dispersing agent may comprise tallow amine.

Organosilicone—In one aspect, the composition may comprise an organosilicone. When present, the organosilicone may comprise, based on total weight of the composition, from about 0.1% to about 30%, from about 0.5% to about 20%, from about 1.0% to about 10%, or from about 1.5% to about 8% of the composition. Suitable organosilicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked. In one aspect, the organosilicones may be linear.

In one aspect, the organosilicone may comprise a non-functionalized siloxane polymer that may have Formula I below, and may comprise polyalkyl and/or phenyl silicone fluids, resins and/or gums.

[R₁R₂R₃SiO_{1/2}]ₙ[R₄R₄SiO_{2/2}]ₘ[R₄SiO_{3/2}]ⱼ (Formula I)

wherein:
i) each R₁, R₂, R₃ and R₄ may be independently selected from the group consisting of H, —OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy, moieties;
ii) n may be an integer from about 2 to about 10, or from about 2 to about 6; or 2; such that n=j+2;
iii) m may be an integer from about 5 to about 8,000, from about 7 to about 8,000 or from about 15 to about 4,000;
iv) j may be an integer from about 0 to about 10, or from about 0 to about 4, or 0;

In one aspect, R₂, R₃ and R₄ may comprise methyl, ethyl, propyl, C₄-C₂₀ alkyl, and/or C₆-C₂₀ aryl moieties. In one aspect, each of R₂, R₃ and R₄ may be methyl. Each R₁ moiety blocking the ends of the silicone chain may comprise a moiety selected from the group consisting of hydrogen, methyl, methoxy, ethoxy, hydroxy, propoxy, and/or aryloxy.

As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

In one aspect, the organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the trade names DC 200 Fluid, DC 1664, DC 349, DC 346G available from offered by Dow Corning Corporation, Midland, Mich., and those available under the trade names SF1202, SF1204, SF96, and Viscasil® available from Momentive Silicones, Waterford, N.Y.

In one aspect, the organosilicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in USPA 2005/0098759, and U.S. Pat. Nos. 4,818,421 and 3,299,112. Exemplary commercially available silicone polyethers include DC 190, DC 193, FF400, all available from Dow Corning Corporation, and various Silwet surfactants available from Momentive Silicones.

In another aspect, the functionalized siloxane polymer may comprise an aminosilicone. Suitable aminosilicones are described in U.S. Pat. Nos. 7,335,630 B2, 4,911,852, and USPA 2005/0170994A1. In one aspect the aminosilicone may be that described in and cite filed X22 application. In another aspect, the aminosilicone may comprise the structure of Formula II:

[R₁R₂R₃SiO_{1/2}]ₙ[(R₄Si(X—Z)O_{2/2}]ₖ[R₄R₄SiO_{2/2}]ₘ[SiO_{3/2}]ⱼ (Formula II)

wherein
i. R₁, R₂, R₃ and R₄ may each be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy;
ii. each X may be independently selected from a divalent alkylene radical comprising 2-12 carbon atoms, —(CH₂)s— wherein s may be an integer from about 2 to about 10; —CH₂—CH(OH)—CH₂—; and/or

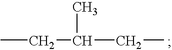

iii. each Z may be independently selected from —N(R₅)₂; —N(R₅)₃A⁻,

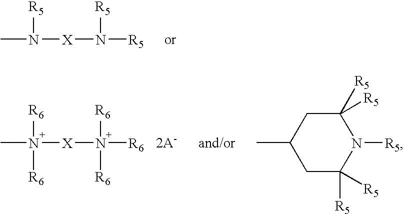

wherein each R₅ may be selected independently selected from H, C₁-C₂₀ alkyl, C₁-C₂₀ substituted alkyl, C₆-C₂₀ aryl, C₆-C₂₀ and/or substituted aryl, each R₆ may be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy; and A⁻ may be a compatible anion. In one aspect, A⁻ may be a halide;
iv. k may be an integer from about 3 to about 20, or from about 5 to about 18 or from about 5 to about 10;
v. m may be an integer from about 100 to about 2,000, or from about 150 to about 1,000;
vi. n may be an integer from about 2 to about 10, or about 2 to about 6, or 2, such that n=j+2; and
vii. j may be an integer from about 0 to about 10, or from about 0 to about 4, or 0;

In one aspect, R₁ may comprise —OH. In this aspect, the organosilicone may be amodimethicone.

Exemplary commercially available aminosilicones include DC 8822, 2-8177, and DC-949, available from Dow Corning Corporation, and KF-873, available from Shin-Etsu Silicones, Akron, Ohio.

In one aspect, the organosilicone may comprise amine ABn silicones and quat ABn silicones. Such organosilicones are generally produced by reacting a diamine with an epoxide. These are described, for example, in U.S. Pat. Nos. 6,903,061 B2, 5,981,681, 5,807,956, 6,903,061 and 7,273,837. These are commercially available under the trade names Magnasoft® Prime, Magnasoft® JSS, Silsoft® A-858 (all from Momentive Silicones).

In another aspect, the functionalized siloxane polymer may comprise silicone-urethanes, such as those described in U.S. PA 61/170,150. These are commercially available from Wacker Silicones under the trade name SLM-21200.

When a sample of organosilicone is analyzed, it is recognized by the skilled artisan that such sample may have, on average, non-integer indices for Formula I and II above, but that such average indice values will be within the ranges of the indices for Formula I and II above.

In one aspect, the composition may have a viscosity of from about 200 cps to about 1,000 cps.

In one aspect, in the presence of a source of anionic surfactant under wash conditions, the composition may form particles having a particle size of from about 0.005 to about 5000 μm, or from about 0.01 to about 2000 μm, or from about 0.05 to about 100 μm.

In one aspect, the composition may form a coacervate under wash conditions. In this aspect, the coacervate may have an elastic and viscous modulus of from about 10 to about 2,000,000 Pa, or from about 100 to about 1,000,000 Pa, or from about 500 to about 500,000 Pa as measured using the Test Methods.

In one aspect, the elastic modulus of the composition may be greater than the viscous modulus at a frequency of 100 rads/sec.

In one aspect, the composition may be capable of providing a ΔL value, as measured using the Test Methods, of from about −0.01 to about −15.

In one aspect, the may be in the form of an additive. In one aspect, the composition may be provided as a unit dose.

Method of Use—In one aspect, a method of providing a fabric benefit comprising the step of contacting the composition as described above with a fabric is disclosed. In one aspect, a method of providing a benefit to a fabric comprising the step of contacting the composition described herein with a fabric is disclosed. In one aspect, the benefit may comprise a benefit selected from the group consisting of color maintenance and/or rejuvenation, cleaning, abrasion resistance, wrinkle removal, pill prevention, anti-shrinkage, anti-static, anti-crease, fabric softness, fabric shape retention, suds suppression, decreased residue in the wash or rinse, improved hand feel or texture, and combinations thereof. In one aspect, the benefit may comprise a color maintenance and/or rejuvenation benefit.

In one aspect, the contacting step of the method may be carried out during a prewash, a wash or rinse step. In one aspect, the method may comprise the step of contacting the composition with a fabric using a top-loading washing machine.

In one aspect, the contacting step may be carried out in the presence of a source of anionic surfactant. Suitable anionic surfactants are known in the art, and include those described in U.S. patent application Ser. No. 12/075,333.

In one aspect, the source of anionic surfactant may comprise, based on total source of anionic surfactant weight, from about 2% to about 50%, or from about 5% to about 25%, or from about 12% to about 20% of an anionic surfactant. In one aspect, the source of anionic surfactant comprises an amount of surfactant sufficient to provide a detersive effect.

In one aspect, the source of anionic surfactant may comprise a conventional detergent. In this aspect, the source of anionic surfactant may be commercially available Tide Free® HE. In this aspect, from about 10 grams to about 100 grams, or from about 50 to about 80 grams of detergent may be used.

In one aspect, the source of anionic surfactant may comprise an anionic surfactant comprising a hydrophilicity-lipophilicity balance (HLB) of from about 4 to about 14, or from about 8 to about 10, or about 9.

In one aspect, the source of anionic surfactant may comprise, based on total source of anionic surfactant weight, from about 1.0% to 50%, or from about 7% to about 40% of alkylethoxysulfonate (AES).

In one aspect, the source of anionic surfactant may comprise, based on total source of anionic surfactant weight, less than about 5%, or less than about 10%, or less than about 50% linear alkyl benzene sulfonate (HLAS). In one aspect, the source of anionic surfactant may comprise less than about 10% nonionic surfactant, or less than about 1% nonionic surfactant. In one aspect, the composition may be essentially free of a nonionic surfactant

In one aspect, the source of the anionic surfactant may be the fabric itself. In this aspect, residual anionic surfactant on a fabric previously washed with an anionic-containing detergent may provide the source of anionic surfactant.

### Test Methods

Viscosity—Viscosity is measured using a Brookfield Viscometer, using the LVT method as provided by the manufacturer. A #2 spindle is used at an rpm of 30. 80 grams of sample is placed into a cylinder having an opening with a 2.0 inch diameter and measured according to the manufacturer's protocol.

Rheology/Adhesive Mapping—The frequency dependence of the material is obtained from a frequency sweep carried out under linear viscoelastic conditions. The structured phase (comprising particles) is separated from wash solutions by centrifugation at a speed and time sufficient to isolate particles as indicated by a substantially clear supernatant. As a result of centrifugation, a viscous gel-like layer comprising coalesced particles forms and separates as the bottom phase. A low viscosity supernatant is present. The supernatant is decanted to isolate the gel-like layer for further testing. The linear viscoelastic region is identified as follows: using a stress-controlled rheometer equipped with parallel plate geometry (12 mm, or 25 mm; selected based on modulus of the gel phase, as readily understood by one of skill in the art), a dynamic stress sweep, where G′ (elastic modulus) and G″ (viscous modulus) are measured as a function of stress, is run at a fixed frequency 1 rad/s. The linear viscoelastic region is defined as the stress range over which G′ and G″ are constant, i.e. independent of stress. A dynamic frequency sweep, where G′ and G″ are measured as a function of frequency between 0.1 and 100 rad/s is then run at a stress within this linear viscoelastic regime. A viscoelastic “window” is then formed by plotting G′ on the y-axis and G″ on the x-axis, with the upper right corner of the window corresponding to the high frequency point i.e. G″ (100 rad/s), G′ (100 rad/s) and the lower left corner corresponding to the low frequency point i.e. G″ (0.1 rad/s), G′ (0.1 rad/s).

Determination of ΔL value—The color and appearance benefit imparted to fabrics can be described, for example, in terms of the refractive index of the fiber before and after treatment of the fabric as defined as a ΔL value measured via spectrophotometry (for example, via a Hunter spectrophotometer as described herein). A decrease in L value, represented by a negative delta L value, indicates an improvement (or darkening) in color, which represents a rejuvenation benefit. In this aspect, the L* value is determined before and after the fabric is treated using the method. The difference, or ΔL, indicates the degree of “rejuvenation” or improvement of appearance in the treated fabric. The ΔL value of the fabric can be determined using the Fabric Damaging Protocol to yield damaged fabrics, followed by the Treatment Protocol. L* values are determined on the damaged and treated fabric. A typical L_{(damaged)} value for a black Gildan T-Shirt described is from about 12 to about 14. The ΔL value is equal to the L_{(damaged)}−the L_{(treated)} value.

Fabric Damaging Protocol—New black Gildan t-shirts (“garment”) (6.1 oz 100% pre-shrunk cotton, double needle stitching, seamless collar, taped neck and shoulders, quarter turned body), available from TSC Apparel, Cincinnati, Ohio, or a suitable equivalent, are used. (Mill Number: 2000; Mill: Gildan; Style number: 0281 GL; Color: Black; Size: Large or extra large.) 49.6±0.01 grams of commercially available 2× Ultra Tide® detergent is used per cycle. Each garment is washed a total of 10 times, with complete drying (approximately 14% residual moisture) in-between each cycle. The wash conditions are as follows: Water: City water having 8.1 gpg average hardness and 1 ppm average chlorine. Washing machine used is Kenmore 80 Series, Heavy Duty, Super Capacity Plus, Quiet Pak, 3 speed motor with 4 speed combination, Ultra Rinse System, model number 110.64832400. Clothing is washed using the “Heavy Duty Fast/Fast” cycle using 17 gallons (64.35 Liters) water having a temperature of about 60° F. for 12 minutes. One two minute rinse is performed using water having a temperature of about 60° F. The total garment weight in the washer is 5.5 pounds (or 11 whole Gildan t-shirts). The garments are then dried using a Kenmore electric 80 Series, Heavy Duty, Super Capacity Plus, Quiet Pak, model number 110.64832400. The garments are dried for about 60 minutes at a temperature of 186° F. (the “Cotton High” cycle). After the drying step, the garments generally have no noticeable moisture, or about 14% residual water content. The wash and dry cycles are repeated for a total of 10 times unless otherwise indicated.

Treatment Protocol—The test composition is diluted in a top loading machine containing 17 gallons of city water (about 8 gpg) at 60° F., for 12 minutes. The garment is then rinsed using 17 gallons 60° F. city water (about 8 gpg), for 2 minutes. The garment is then dried to the touch (i.e., until garment has approximately 14% residual moisture).

Dilution under Wash Conditions—Preparation of samples under wash conditions for characterization of particle size and/or rheology is as follows: 50.5 grams of Tide 2×, available from The Procter and Gamble Company (containing 20.06% AES, 2.67% HLAS and 0.80% Nonionic Surfactant) and 80 grams of sample composition is added to a Kenmore 80 Series, Heavy Duty, Super Capacity Plus, Quiet Pak, 3 speed motor with 4 speed combination, Ultra Rinse System, model number 110.25842400 top-loading washing machine. The mixture is allowed to agitate in the machine using the “Heavy Duty Fast/Fast” cycle having 17 gallons (64.35 Liters) water at a temperature of about 60° F., and stopped after 12 minutes. Water quality is 6 gpg. Samples of the solution are extracted immediately after the cycle is stopped for characterization of particle size or rheology as described herein.

Particle sizing—Particle size and structure in neat product (i.e., undiluted composition as described herein) is determined via light microscopy. A drop of neat product is placed on a glass microscope slide and covered with a glass coverslip. The coacervate particles are identified by their birefringent nature indicating a liquid crystalline character. These coacervate particles can be identified from other possible particulates in the formulation both by this birefringent nature, and either by inspection of the formulation in the absence of cationic polymer, and hence, in the absence of coacervate formation, or by systematic evaluation of other components in the mixture. Quantification of primary and colloidal particle size is completed by image analysis of the microscopy pictures. Often enhanced contrast techniques are used to improve contrast between the coacervate particles and the surrounding liquid, including differential interference contrast, phase contrast, polarized light, and/or the use of fluorescent dyes. Additional droplets are imaged to ensure that the resulting images and particle sizes are representative of the entire mixture.

Particle size under dilution may be determined using microscopy (light microscopy as described above, or electron microscopy if the particles are too small to be visible by light microscopy) and/or laser scattering techniques such as laser diffraction with Mie theory, dynamic light scattering, or focused beam reflectance mode. Often these techniques are used together, in that microscopy is used to identify the coacervate particles from other possible particulates in solution and scattering techniques offer a more rapid quantification of particle size. The choice of scattering method depends on the particle size of interest and the concentration level of particles in solution. In dynamic light scattering (DLS), the fluctuations in scattered light due to Brownian motion of the particles are measured. These fluctuations are correlated to obtain a diffusion coefficient and therefore a hydrodynamic radius of particles. This technique is used when the particles are less than a few microns and the solution conditions are dilute. In laser diffraction, the light scattered by the particles is measured by a series of detectors placed at different angles. The use of back scattering detectors and Mie theory enables detection of particle sizes less than 1 micron. This technique can be utilized to measure particles over a broader size range compared to DLS, and resolution of two populations of particle sizes (such as primary and colloidal particles) can be determined provided the difference in sizes is significant enough. In a focused beam reflectance measurement (FBRM), a chord length distribution, which is a “fingerprint” of the particle size distribution, is obtained. In FBRM, a focused laser beam scans across particles in a circular path, and as the beam scans across particles the backscattered light is detected as pulses of light. The duration of the pulse is converted to a chord length, and by measuring thousands of chord lengths each second, the chord length distribution is generated. As in the case of laser diffraction, detection of two size populations can be obtained provided the differences in size is great enough. This technique is used when the particles are greater than approximately 1 micron and is particularly useful when the turbidity and/or particle concentration in solution is high.

### EXAMPLES

| | Example (% active) | | | | | | | | | | |
|---|---|---|---|---|---|---|---|---|---|---|---|
| Component Material | I | II | III | IV | V | VI | VII | VIII | IX | X | XI |
| AE3S NH4¹ | 2.0 | — | 3.0 | — | — | — | — | — | — | — | 2.0 |
| AE 1.8S² | — | 5.0 | — | 3.0 | 2.0 | — | — | — | 5.0 | — | — |
| HLAS³ | — | — | — | — | — | 3.0 | 5.0 | 7.0 | — | — | — |
| Surfonic 24-9⁴ | 3.0 | 5.0 | 2.0 | 5.0 | 4.0 | 10.0 | 12.0 | 15.0 | 7.0 | — | 1.0 |
| Merquat ® 100⁵ | — | — | 3.0 | 3.0 | — | 6.0 | — | 3.0 | 3.0 | 6.0 | 2.0 |
| Merquat ® 106⁶ | 3.5 | 3.5 | — | — | — | — | — | — | — | — | — |
| Merquat ® 280⁷ | — | — | — | — | 5.0 | — | 5.0 | — | — | — | — |
| Betaine⁸ | 7.0 | 5.0 | 7.0 | 8.0 | 3.0 | 5.0 | 5.0 | 7.0 | 8.0 | 7.5 | 7.0 |
| TAE80⁹ | — | — | — | — | — | 2 | — | — | — | — | 1 |

| | |
|---|---|
| Water | Balance to 100% |

¹Alkyl ethoxylate sulfate, 3 moles of ethoxylation, available from The Procter & Gamble Co.
²Alkyl ethoxylate, available from The Procter & Gamble Company
³Linear alkylbenzene sulfonate, available from The Procter & Gamble Company
⁴Nonionic surfactant, available from Huntsman Corp
⁵Homopolymer of diallyldimethyl ammonium chloride, polymer molecular weight of from about 100,000 to about 150,000.
⁶Homopolymer of diallyldimethyl ammonium chloride, polymer molecular weight from about 5,000 to about 15,000.
⁷Co-polymer of dimethyldiallyl ammonium chloride and acrylic acid, molecular weight of about 450,000 to 550,000 Daltons.
⁸lauryl amido propyl betaines, or C12-C16 cocoamido propyl betaines (supplied from Inolex under the tradename Lexaine ® CG30).
⁹Dispersing agent, ethoxylated tallow amine, available from BASF.

### Example XII-XXI

| | Example (% Active) | | | | | | | | | |
|---|---|---|---|---|---|---|---|---|---|---|
| Component Material | XII | XIII | XIV | XV | XVI | XVII | XVIII | XIX | XX | XXI |
| AE3S NH4¹⁰ | 5 | — | 7.5 | — | — | — | — | — | — | — |
| AE 1.8S¹¹ | — | 7.5 | — | 7.5 | 7.5 | — | — | — | 7.5 | — |
| HLAS¹² | — | — | — | — | — | 10 | 5 | 10 | — | 5 |
| Surfonic 24-9¹³ | 15 | 15 | 15 | 15 | 15 | 22 | 15 | 25 | 15 | 12 |
| Merquat ® 100¹⁴ | — | — | 3 | 3 | — | 6 | — | 3 | 3 | 3 |
| Merquat ® 106¹⁵ | 3.5 | 3.5 | — | — | — | — | — | — | — | — |
| Merquat ® 280¹⁶ | — | — | — | — | 5 | — | 5 | — | — | — |

| | |
|---|---|
| TAE80¹⁷ | Optionally, 2 |
| Water | Balance to 100% |

¹⁰Alkyl ethoxylate suflate, 3 moles of ethoxylation, available from The Procter & Gamble Co.
¹¹Alkyl ethoxylate, available from The Procter & Gamble Company.
¹²Linear alkylbenzene sulfonate, available from The Procter & Gamble Company.
¹³Nonionic surfactant, available from Huntsman Corp.
¹⁴Homopolymer of diallyldimethyl ammonium chloride, polymer molecular weight of from about 100,000 to about 150,000.
¹⁵Homopolymer of diallyldimethyl ammonium chloride, polymer molecular weight from about 5,000 to about 15,000.
¹⁶Co-polymer of dimethyldiallyl ammonium chloride and acrylic acid, molecular weight of about 450,000 to 550,000 Daltons.
¹⁷Dispersing agent, ethoxylated tallow amine, available from BASF.

### Example XXII

### Method of Making

806.5 grams of distilled water is placed in a mixing vessel. A mixing propeller is lowered into the water. Using a 60 mL syringe, 60.6 grams of alkyl ethoxylate sulfate, 3 moles of ethoxylation, (33% active) is slowly added as a steady stream to the water with stirring until all surfactant is added. The mixture of water and anionic surfactant is stirred for 30 minutes with medium to high agitation. After complete dispersion of the anionic surfactant, 30 grams of Surfonic® 24-9 (100% active) is added in the same manner. The mixture is then allowed to mix for at least 1 hour or until all solid surfactant is dispersed. 102.9 grams of Merquat® 106, homopolymer of diallyldimethyl ammonium chloride (34% active), available from Nalco, is then added to the mixture. The polymer is added very slowly using a syringe and allowed to mix for 45 to 60 minutes.

### Example XXIII

### Method of Making

573.5 grams of distilled water is placed in a mixing vessel. A mixing propeller is lowered into the water. Using a 60 mL syringe, 60.6 grams of alkyl ethoxylate sulfate, 3 moles of ethoxylation, (33% active) is slowly added as a steady stream to the water with stirring until all surfactant is added. The mixture of water and anionic surfactant is stirred for 30 minutes with medium to high agitation. After complete dispersion of the anionic surfactant, 30 grams of Surfonic® 24-9 (100% active) is added in the same manner. After complete dispersion of the anionic surfactant, 233 grams of a 30% active solution of Lexaine® is then added in the same manner. The mixture is then allowed to mix for at least 1 hour or until all solid surfactant is dispersed. 102.9 grams of Merquat® 106, homopolymer of diallyldimethyl ammonium chloride (34% active), available from Nalco, is then added to the mixture. The polymer is added very slowly using a syringe and allowed to mix for 45 to 60 minutes.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising
a. from about 1% to about 12%, based on total weight of the composition, of a cationic polymer;
b. from about 1% to about 20%, based on total weight of the composition, of an amphoteric surfactant;
c. optionally, from about 1% to about 30%, based on total weight of the composition, of an anionic surfactant;
d. optionally, from about 1% to about 20%, based on total weight of the composition, of a nonionic surfactant;
e. optionally, a dispersing agent,
wherein said composition is isotropic.

2. A composition according to claim 1, said composition comprising
a. from about 1% to about 12%, based on total weight of the composition, of a cationic polymer
b. from about 1% to about 10%, based on total weight of the composition, of an amphoteric surfactant;
wherein said composition is essentially free of anionic surfactant and/or nonionic surfactant.

3. A composition comprising
a. from about 1% to about 12%, based on total weight of the composition, of a cationic polymer
b. from about 1% to about 20%, based on total weight of the composition, of a nonionic surfactant;
wherein said composition is essentially free of anionic surfactant

4. A composition according to claim 1, said composition consisting essentially of
a. from about 1% to about 12%, based on total weight of the composition, of a cationic polymer;
b. from about 1% to about 30%, based on total weight of the composition, of an anionic surfactant;
c. from about 1% to about 10%, based on total weight of the composition, of an amphoteric surfactant; and
d. a carrier.

5. A composition according to claim 1, said composition comprising a ratio of amphoteric surfactant to anionic surfactant of from about 1:1 to about 3:1.

6. A composition according to claim 1, wherein said cationic polymer is selected from the group consisting of cationic polysaccharide, polyethylene imine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethylammonium chloride), poly(acrylamide-co-diallyldimethylammonium chloride-co-acrylic acid), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride).

7. A composition according to claim 1, wherein the anionic surfactant comprises a material selected from the group consisting of C₈-C₂₂ fatty acid or its salts; C₁₁-C₁₈ alkyl benzene sulfonates; C₁₀-C₂₀ branched-chain and random alkyl sulfates; C₁₀-C₁₈ alkyl ethoxy sulfates, wherein x is from 1-30; mid-chain branched alkyl sulfates; mid-chain branched alkyl alkoxy sulfates; C₁₀-C₁₈ alkyl alkoxy carboxylates comprising 1-5 ethoxy units;
modified alkylbenzene sulfonate; C₁₂-C₂₀ methyl ester sulfonate; C₁₀-C₁₈ alpha-olefin sulfonate; C₆-C₂₀ sulfosuccinates; and combinations thereof.

8. A composition according to claim 1, wherein the nonionic surfactant comprises a surfactant selected from the group consisting of ethoxylates, multihydroxyl surfactants, and combinations thereof.

9. A composition according to claim 6, wherein the amphoteric surfactant comprises a surfactant selected from the group consisting of N-alkyl aminoproprionates, N-alkyl betaines, N-alkyl glycinates, carboxy glycinates, alkyl imidazoline-based surfactants, amine oxides, and combinations thereof.

10. A composition according to claim 1, wherein said composition comprises, based on total weight of the composition, from about 0.1% to about 10% of a dispersing agent.

11. A composition according to claim 8 wherein said dispersing agent comprises a fatty amine selected from the group consisting of octyl amine, lauryl amine, stearyl amine, oleyl amine, tallowamine, cetylamine, N-tetradecylamine, cocoamine, hydrogenated tallowamine, alkyl (C₁₆ and C₁₈-unsaturated) amine, alkyl(C₁₄₋₁₈) amine, alkyl(C₁₆₋₂₂) amine, alkyl(C₈₋₁₈ and C₁₈-unsaturated) amine, alkyl(C₁₂₋₁₈) amine, di(hydrogenated tallow)amine, dicocoalkyl amine, dialkyl(C₁₄₋₁₈) amine, dialkyl(C₁₂₋₁₈) amine, dialkyl(C₁₆₋₂₂) amine, N-tridecyltridecanamine, N-methylstearylamine, distearyl amine, dialkyl(C₈₋₂₀) amine, N-octadecylbenzylamine, N-isopropyloctadecylamine, N-hexadecyloctadecylamine, dimantine, N-methyldioctadecylamine, dimethyl palmitamine, cocodimethylamine, alkyl(C₁₀₋₁₆)dimethyl amine, alkyl(C₁₄₋₁₈)dimethyl amine, alkyl(C₁₆₋₁₈ and C₁₈-unsaturated)dimethyl amine, alkyl(C₁₆₋₁₈)dimethyl amine, Alkyl(C₁₂₋₁₈)dimethyl amine, alkyl(C₁₆₋₂₂)dimethyl amine, oleyldimethylamine, N-methyldidecylamine, N,N-dioctylmethylamine, dicocomethylamine, dihydrogenated tallowmethyl amine, trialkyl(C₆₋₁₂) amine, N,N-dioctyloctyl amine, trialkyl(C₈₋₁₀) amine, cocopropylenediamine, laurylpropylenediamine, N-dodecylpropylenediamine, laurylamine dipropylenediamine, N-(tallow alkyl)dipropylenetriamine, N-(tallow alkyl)dipropylenetriamine, N-stearoyltetraethylenetetramine, and combinations thereof.

12. A composition according to claim 1, wherein said composition comprises an organosilicone.

13. A composition according to claim 1, wherein the composition has a viscosity of from about 200 cps to about 1,000 cps.

14. A composition according to claim 1, wherein said composition, under wash conditions in the presence of a source of anionic surfactant, forms particles having a particle size of from about 0.005 to about 5000 μm.

15. A composition according to claim 1, wherein said composition forms a coacervate under wash conditions, said coacervate having an elastic and viscous modulus of from about 10 to about 2,000,000 Pa as measured using the Test Methods.

16. A composition according to claim 1, wherein the elastic modulus of the composition is greater than the viscous modulus at a frequency of 100 rads/sec.

17. A composition according to claim 1, said composition capable of providing a ΔL value, as measured using the Test Methods, of from about −0.01 to about −15.

18. A method of providing a fabric benefit comprising the step of contacting the composition of claim 1 with a fabric.

19. A method according to claim 18, wherein the contacting step is carried out in the presence of a source of anionic surfactant.

20. A method of providing a fabric benefit comprising the step of contacting the composition of claim 1 with a fabric using a top-loading washing machine.
